(19) United States
(12) Patent Application Publication
(10) Pub. No.: US 2014/0233907 A1
(43) Pub. Date: Aug. 21, 2014

(54) METHOD AND APPARATUS FOR CREATING AND SHARING MULTIPLE PERSPECTIVE IMAGES

(71) Applicants: Thomas Anderson, Rocky River, OH (US); Karl W. Hauber, Kirtland, OH (US)

(72) Inventors: Thomas Anderson, Rocky River, OH (US); Karl W. Hauber, Kirtland, OH (US)

(21) Appl. No.: 13/975,467

(22) Filed: Aug. 26, 2013

Related U.S. Application Data
(60) Provisional application No. 61/766,036, filed on Feb. 18, 2013.

(51) Int. Cl. H04N 9/86

(52) U.S. Cl. CPC H04N 9/86
USPC 386/225

(57) ABSTRACT

The present disclosure provides for a recording device for creating an enhanced personalized image product. The recording device can include a display unit having a graphical user interface. The recording device can comprise a first camera and a second camera simultaneously recording a first image and a second image in a first person perspective and a second person perspective (or another first person perspective), respectively. A unit controller can be operatively coupled to the display unit and the recording unit. The unit controller can comprise a processor and a memory operatively coupled to the processor. The unit controller can be programmed to cause the recorded images to be generated on the display unit. The unit controller and the graphical user interface can allow a user to view the recorded images of the person and edit the recorded images on a single display unit.

The present invention claims priority on U.S. Provisional Patent Application Ser. No. 61/766,036, filed Feb. 18, 2013 which is fully incorporated herein by reference.

### BACKGROUND

This invention relates generally to video and/or still picture production, and, in particular, to a system, device, and methods which personalize a recorded (or pre-recorded) video and/or still picture with multiple perspectives. The method can provide multiple segments or perspectives of a captured or recorded event/activity that are completed using simultaneously (or sequentially) captured, recorded, shared, narrated, and/or downloaded imagery, sound, or other effects. It is to be appreciated that the activities can be recorded in real time.

It is now possible to personalize certain consumer products once constrained to having a dedicated message. Hallmark Cards, for example, now provides a computer-controlled machine for vending personalized greeting cards. As described in U.S. Pat. No. 5,036,472, this system, configured in the form of a kiosk, provides specific instructions to a customer so, as to personalize a greeting card with the name and birthdate of an intended receiver, the name of the sender, and so forth. The data entering mode may further include operations for viewing and correction of the entered data. Upon final approval, a product handling mechanism prints the customized card and transfers the finished item to a delivery receptacle.

Additionally Hallmark is now advertising a greeting card that may be customizable with sound. In this product, a voice is recorded during a record mode and stored in a solid-state integrated circuit supported within the card. Following this record mode, when the recipient opens the card, the person hears a replay of the greeting previously stored by the sender.

In addition to the personalization of greeting cards and other communications products available in printed form, it would be advantageous and entertaining to provide video or still imagery based materials having a personalized format. A system that relies entirely upon the operator for a performance may suffer from a lack of perspective, reference, context, and/or impact. Also, the recording of a completely customized video product requires that the recording process consume as much time or more than final playback, which may be unsuitable for certain consumer applications, including kiosk-like installations.

U.S. Pat. No. 5,099,337 “Method and Apparatus for Producing Customized Video Recordings” illustrates the degree of sophistication required in a system capable of producing an entirely customized video recording. This patent teaches audio/video reproduction equipment for displaying prompt information, including an audio signal used for synchronization. A first video signal representative of background information and a second video audio signal are combined along with creative modifications which may be subsequently added. The purpose of this prior-art system is not to reduce the demands on the performer, but rather to provide a smaller, more manageable apparatus which will create an open atmosphere for a more or less professional recording.

There is therefore remaining a need for a method and apparatus for producing customized still images and video recordings which provide at least two perspectives in order to place into context and highlight the visual effect and emotions of an activity or event. Typically what is lacking is the recording of oneself (i.e. from a second person perspective view) while one is recording or viewing the activities/images that they see in front of them (i.e. from a first person perspective view). Enhanced visual effects and different perspectives provide more interesting images to share.

### SUMMARY

The present disclosure provides apparatuses and methods for the efficient production of personalized video stories and/or still imagery. The methods include the steps of recording a personalized or non-personalized video story (or still imagery) having one or more uncompleted segments, or lacking a second perspective view, to be personalized, supplemented, or augmented including another perspective view or recording.

The present disclosure further provides for an entertainment sharing system for sharing a personalized video product. The entertainment sharing system can have a recording device including a display unit that is capable of recording, generating, and transmitting video images. The recording unit is capable of recording a first video image of a person. The entertainment sharing system is capable of interspersing the first video image of the person with a second stock video image to create the personalized video product. The second stock video image can be associated with a particular activity image. The personalized video product can be selected from the group consisting of side-by-side images, PIP, and foreground/background of the first video image of the person and the second stock video image. The entertainment sharing system can include a service network capable of transmitting the personalized video product to a selected recipient.

The present disclosure still further provides for an entertainment system for creating a personalized image product. The entertainment system can comprise a single device including a display unit having a graphical user interface. The entertainment system can have dual recording units recording images of a person in a second person perspective, and an event in a first person perspective. A unit controller can operatively be coupled to the display unit and the recording unit. The unit controller can comprise a processor and a memory operatively coupled to the processor. The unit controller can be programmed to cause the recorded images associated with the person and the event to be generated on the display unit. The unit controller and the graphical user interface can allow the person to view the recorded images of the person and the event and edit the recorded images on a single display unit. The entertainment system can further comprise a communication interface wherein the communication interface allows the recorded images to be shared with a service network.

The present disclosure yet still further provides for a recording device for creating a personalized image product. The recording device can include a display unit having a graphical user interface. The recording device can comprise a first camera and a second camera simultaneously recording a first image and a second image in a first person perspective and a second person perspective, respectively. A unit controller can be operatively coupled to the display unit and the recording unit. The unit controller can comprise a processor and a memory operatively coupled to the processor. The unit controller can be programmed to cause the recorded images to be generated on the display unit. The unit controller and the graphical user interface can allow a user to view the recorded images of the person and edit the recorded images on a single display unit.

### BRIEF DESCRIPTION OF THE DRAWINGS

FIG. 1 is a simplified schematic displaying a split screen combination of images according to a first embodiment of the present disclosure.

FIG. 2 is a simplified schematic displaying a split screen combination of images according to a second embodiment of the present disclosure.

FIG. 3 is a schematic diagram showing a dual camera apparatus according to the present disclosure.

FIG. 4 is a schematic diagram of an apparatus and split screen image display according to the present disclosure.

### DETAILED DESCRIPTION

The present invention provides hardware apparatuses, devices, and methods whereby a recorded video story or pictorial images may be personalized by combining live or digitally captured images to segments of the recorded story. In addition to personalized imagery, the system, which will subsequently be described in detail, is adaptable to the inclusion of personalized sound effects, narration, dialog, or music. The system is additionally capable of including captioning such as an individual's name or other information as part of the personalization of the underlying video or pictorial story.

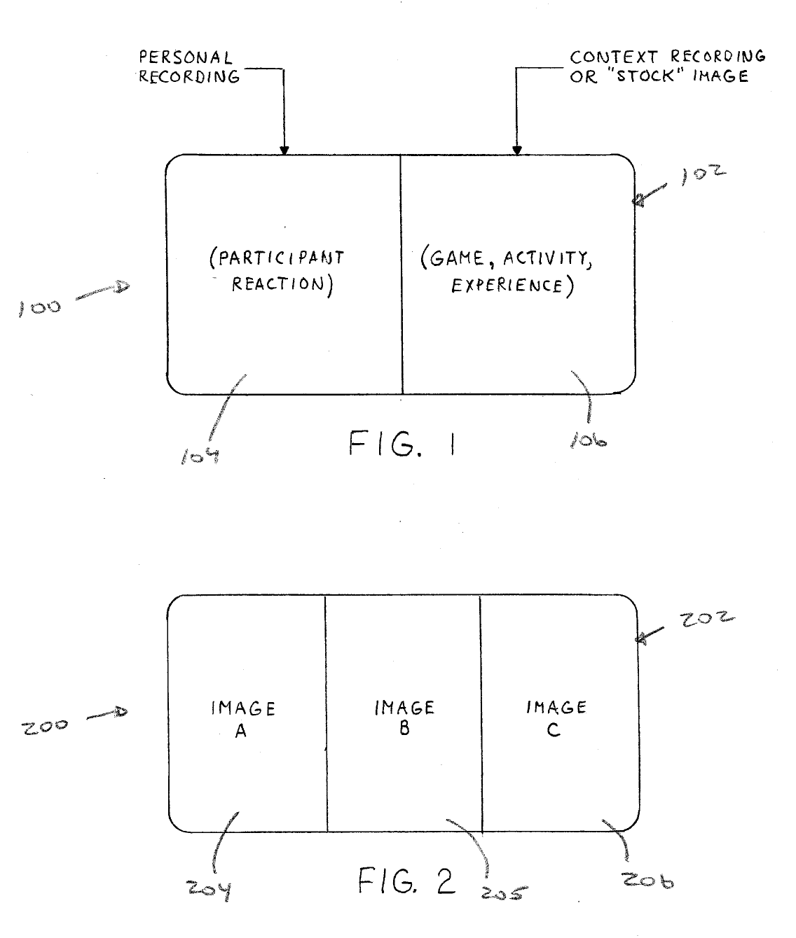

Referring to FIGS. 1-4, an entertainment system or image capturing device 100, 200, 300, 400 is provided including a method for creating and sharing a personalized video or still imagery product. The entertainment system can include a display unit 102, 202, 402 having a graphical user interface (i.e. touch screen, keyboard, or keypad). The entertainment system can have a single or dual recording unit(s) 304, 306 (i.e. dual cameras or dual video imaging recorders) capable of recording and capturing still and video images of a person 310 and other events, activities, and objects 312, and generating still and video images (i.e. replays of captured imagery). A unit controller can operatively be coupled to the display unit and to the recording unit. The unit controller can comprise a processor and a memory operatively coupled to the processor. The unit controller can be programmed to cause the recorded still or video images associated with the person 310, and with the event, activity, or experience 312, to be generated on the display unit. The unit controller and the graphical user interface can allow the person to view the recorded still or video images of the person 310 and event 312 and edit the recorded still or video images. The entertainment system can further comprise a communication interface wherein the communication interface allows the recorded still or video images to be shared with a service network (not illustrated).

The entertainment system can further comprise a stock video clip or stock still image (i.e. clip art) relating to an entertainment activity interspersed with the recorded video images of the person 310. The service network can be a social network. The service network can be selected from the group consisting of video postcard, email, and cell phone. Sharing the recorded video or pictorial images can include downloading to a portable electronic device.

The entertainment sharing system can have a recording device including the display unit 102, 202, 402 that is capable of recording, generating, and transmitting still and video images. The recording unit is capable of recording a first still or video image of a person. The entertainment sharing system is capable of augmenting or interspersing the first still or video image of the person 310 with a second stock still or video image (i.e. clip art or clip video) to create the personalized video product. Alternatively, the second stock still or video image can be associated with a particular activity, entertainment image, or experience. The second still or video image can be an electronic or computer generated image of the particular activity, entertainment image, or experience. The second still or video image can be an actual second recording 312 from the recording unit 300 that displays a different perspective than the first still or video image of a person 310.

The personalized video or imagery product display can be selected from the group consisting of a split screen (i.e. side-by-side (SBS) images 102, 202, above and below images, picture-in-picture (PIP) 402, and foreground/background images, etc.) of the first still or video image of the person and the second stock still or video image. The entertainment sharing system can include a service network capable of transmitting the personalized still image or video product to a selected recipient.

The entertainment system can further comprise the recording of the first still or video image of the person which is initiated based on a predeterminable event of the entertainment sharing system. The predeterminable event can be, for example, a winning game on a gambling unit, a start of a ride, a beginning of an experience, initiation of an activity, etc. It is to be appreciated that the event can be anything wherein one wants to capture both the event and one's own reaction to the event.

Access to the service network can be dependent upon indicia of credit amount or payment amount. The entertainment system further comprises a second communication interface allowing the entertainment system to communicate with the service network which can be located outside the entertainment system. The service network can be a social network.

The entertainment system further provides for access to the service network without requiring a game of chance to be played, starting of a ride, participating in an experience, nor initiation of an activity, etc.

In another embodiment, an entertainment sharing system is provided which includes a method for sharing a personalized still image or video product. The entertainment sharing system can have a recording device including a display unit including the means for recording, generating, and transmitting still and video images. The recording unit 300 is capable of recording a first still or video image of a person 310. The recording unit 300 is also capable of recording a second still or video image of an associated activity 312 simultaneous with, or subsequent to, the recording of the first still or video image 310. The entertainment sharing system then can intersperse/combine the first still or video image of the person 310 with the second still or video image of the associated activity 312 to create the personalized video product. The second still or video image can be associated with a particular activity, entertainment image, or experience and reflects the context of what the first still or video image was in response thereto. It is to be appreciated that the second still or video image can alternatively be an electronic or computer generated representation of the particular activity, entertainment image, or experience recalled from the entertainment sharing system.

The personalized still image or video product can be compiled using at least a pair of recorded simultaneous or sequential images related to each other and can be displayed in a manner selected from the group consisting of a split screen (i.e. SBS images, above and below images, PIP, and foreground/background images, etc.) with respect to the first still or video image of the person and the second still or video image. The entertainment sharing system can include a device having memory for saving the personalized still image or video product.

The entertainment system, including the recording devices, can further comprise the self-initiated and/or user activated recording of the first still or video image of the person and/or the recording of the second still or video image.

The system described above enables a user of the entertainment system the ability to record themselves or others, or allows recording of the user, in some particular activity or experience. The experience, in many situations, will only be captured by a single or individual image recording device 300. The single image recording device can capture the immediate reaction of a person 310 as he/she is experiencing the activity 312 in real time (i.e. a first scene). Once the experience has been recorded, and in particular the user's reaction in real time to the experience, the recorded image can be modified to place context to the user's reaction. The context modification allows the user to insert, amend, or intersperse the real time reaction with a ‘stock’ image or video, computer generated representation, or a second recorded image or video (i.e. a second scene), which will show what the experience entailed. Thus, once the image has been modified the user can share with others. The modified image will immediately communicate to the recipients the real time reaction of the user/sender and what the reaction was in response to (via the context insert).

In one embodiment, a split screen or PIP view or image will be created and shared which shows on one side, or in one area, the real time reaction of the user alongside a ‘stock’ image or actual image showing a particular activity or experience (context).

In another embodiment, a split screen or PIP view or image will be created and shared which shows on one side, or in one area, a first real time reaction image of the user alongside, or surrounded by, a second recorded image showing a particular activity or experience (context). The two images can be created simultaneously or can be created and synchronized such that the video duration of the first image matches the video duration of the second image. The recipients of the created images will instantly know what the user was doing and the reaction in response thereto.

The method described above can further include digitally keying out a portion of the stored digital sequence so that images of the subject appear within the digitally keyed-out portion. The size and position of the keyed-out portion can be substantially similar in each segment as the segments are replayed. The image of the subject can include a facial likeness. The method can further include the steps of: capturing personalized textual information; and merging the personalized textual information with the stored sequence. It is to be appreciated that the stored sequence can also include a personalized audio recording or sound track, wherein the personalized audio recording or sound track can be merged with the stored sequence. Additionally, the method can further include the steps of: prerecording a plurality of unpersonalized video stories, each such story having a finished portion and a plurality of blank segments; and choosing one of the unpersonalized video stories for personalization.

In another embodiment an entertainment system for creating a personalized image product can be described as follows. The entertainment unit can include a display unit having a graphical user interface and a recording unit capable of recording images of a person in first person perspectives, second person perspective, and/or third person perspective and generating the associated images therefrom. A unit controller can be operatively coupled to the display unit and the recording unit. The unit controller can comprise a processor and a memory operatively coupled to the processor. The unit controller can be programmed to cause the recorded images associated with the person to be generated on the display unit. The unit controller and the graphical user interface can allow the person to view the recorded images of the person and edit the recorded images on a single display unit. The entertainment system can further comprise a communication interface wherein the communication interface allows the recorded images to be shared with a service network.

It is to be appreciated that the images can be video images and/or still picture images, including audio of real time action and/or narration, or later recorded narration. In one example, the entertainment system can include at least a first image and a second image generated on the display unit; wherein, the first image and the second image are both selected from a group of images consisting of the first person perspective images, the second person perspective image, and the third person perspective image. The first image and the second image generated on the display unit can be synchronized and simultaneous. Alternatively, the first image and the second image generated on the display unit can be synchronized and sequential. Alternatively, the first image and the second image generated on the display unit can be non-synchronized and simultaneous; or non-synchronized and sequential.

In another example, at least a first image, a second image, and a third image can be generated on the display unit; wherein, the first image, the second image, and the third image are selected from a group of images consisting of the first person perspective images, the second person perspective image and the third person perspective image. The first image, the second image, and the third image generated on the display unit can be synchronized and simultaneous in a split screen or PIP arrangement in a predeterminable order or predeterminable sequence. The predeterminable order or sequence can be selected from the group consisting of: the first person perspective image-the second person perspective image-the third person perspective image; the first person perspective image-the third person perspective image-the second person perspective image; the second person perspective image-the first person perspective image-the third person perspective image; the second person perspective image-the third person perspective image-the first person perspective image; the third person perspective image-the first person perspective image-the second person perspective image; and, the third person perspective image-the second person perspective image-the first person perspective image. It is to be appreciated that dual first person perspectives can be substituted in the group listed above.

Various other types of user interaction are also possible. For example, the selection of a pre-recorded non-personalized story and/or aspects relating to the stored digital sequences may be partially or entirely automated in accordance with characteristics derived with regard to the user. For example, certain types of non-personalized stories may be made available in accordance with the user's age or other characteristics, interests or desires. Alternatively, depending upon the same or other physical characteristics or attributes, the digital sequences may be selected or used in a particular way. Assuming a non-personalized story has, say, unfinished segments, there may be sequences available in computer memory for use in completing the unfinished segments. Depending upon derived user characteristics, through a fill-in card, touch screen or direct input, a particular subset of the total available sequences might be selected accordingly. As just one example of many, if the subject is a child, sequences most appropriate for such an individual might be automatically selected and incorporated into the story. In general, the use of the digital sequences within the stories is intentionally very flexible, and, as will be mentioned later, a sequence might be repeated or looped during the recording of a segment, using, for example, a one second sequence times in order to fill a second segment. Various other alternatives are possible, including the ability to have the template remain in the same place from segment to segment, or change size and position during a segment or between segments.

Although the non-personalized video stories are preferably provided with unfinished segments which are blank, they need not be entirely blank, depending upon the technology. For example, a pre-recorded sound track may continue through a visually blank sample and remain non-personalized. Alternatively, using a personalized audio input, a blank segment may be entirely personalized, both in terms of audio and visual effects, including text. As a further alternative, depending upon the technology available, an uncompleted segment need not be entirely visually blank. That is, with the ability to digitize a tape section and re-record that section in real time, it should be possible to provide non-personalized video stories wherein only a very small aspect or portion of the segment requires personalization, such as only the facial area. For example, with a non-personalized video story provided in digital form such as on a CD-ROM, such an exacting mode of personalization might be possible though not practical on another medium, such as video tape.

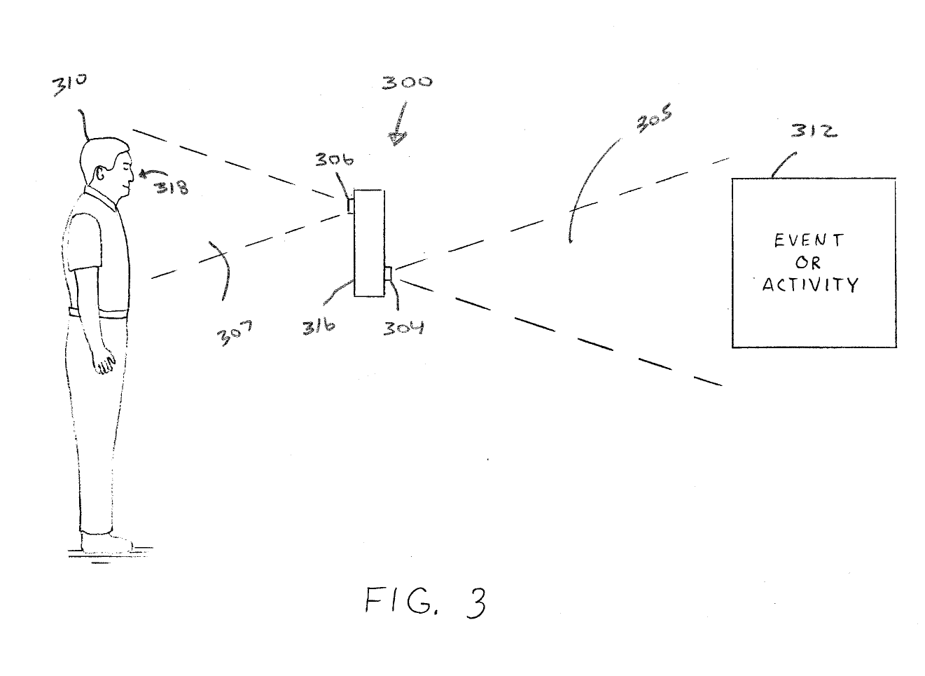

In still another embodiment, a recording device (FIG. 3) is provided including two cameras 304, 306. A first camera 304 can be directed for recording a first person perspective 305 and a second camera 306 can be provided for recording a second person perspective 307. Both cameras 304, 306 can be integrated into a single or individual device 300 and can be generally directed in opposing directions. The first camera 304 can represent the typical single lens camera incorporated into most camera devices well known in the present art. The second camera 306 can represent a camera lens generally directed back at the first person 310 for recording the actions and reactions of the first person. The second camera 306 can generally record the actions of the first person 310 in a somewhat ‘modified’ second person perspective 307. The second camera 306 does not reflect a ‘pure’ second person perspective 307 because the first person 310 can ‘control’ both the first and second cameras 304, 306 and both the first and second person perspectives 305, 307, due to both cameras being integrated into a single device 300. In this manner, both cameras 304, 306 move generally together as the device 300 is moved. Albeit, the cameras 304, 306 and views 305, 307 can be generally opposed to each other due to the cameras 304, 306 facing opposite directions (i.e. the views or fields of vision 305, 307 are approximately 180 degrees apart from each other). It is to be appreciated that the recording device comprises: a first camera 304 which can include a forward facing field of view 305 and a second camera 306 which can include a rearward facing field of view 307.

In one exemplary arrangement, the first camera lens 304 and the second camera lens 306 are of the same configuration. In another embodiment, the first camera 304 can be a standard camera lens and the second camera 306 can be a ‘fisheye’ lens, or wide angle lens, providing for a larger viewing or wider angle perspective to compensate for the closeness of the first person (or object) to the lens itself. In still another exemplary arrangement, each lens can have independent movement and independent control, separate from the device movement, in order to better capture and center both events (not shown). For example, the second camera 306 can include a roving, tracking, or motion sensitive lens that moves to center and/or auto-focus the first person 310 into a framed view. Independent movement, flexibility, reach, and control of each camera can provide for better framing of the event 312 and of the user 310 of the device. The recordings can include digital still images, video images, and/or audio.

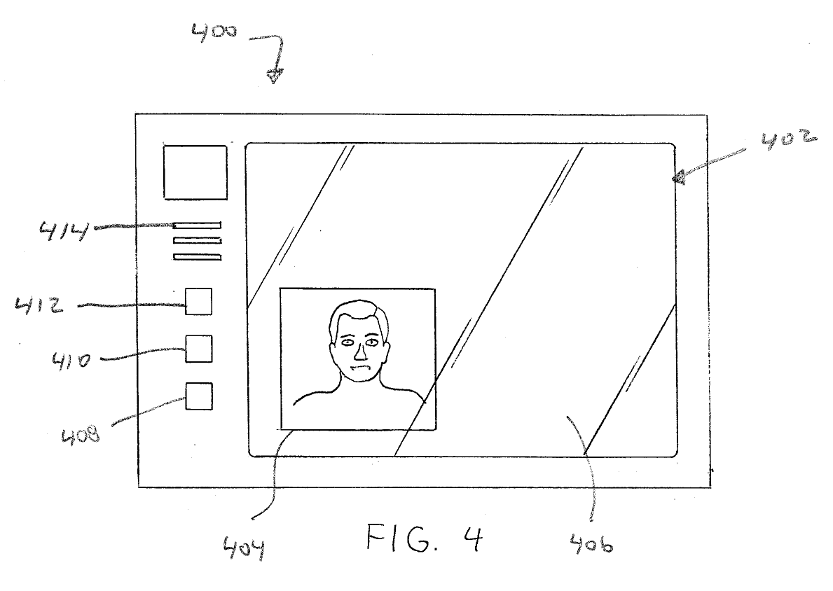

Since a single person 310 is capturing both the first and second person perspectives 305, 307 and must try and maintain focus on the first person perspective 305 of an event 312, the device 300 can be equipped with a light, indicator, or target sight 316 that indicates to the user 310 that the device (i.e. second camera 306) is ‘centered’ on the user 310 for the second person perspective 307 recording. The indicator 316 can provide feedback to the user 310 that the device 300 is centered on the user 310 while simultaneously allowing the user 310 to concentrate on capturing the event 312 in front of the user 310 and in front of the first camera 304. The device 300 can provide the feedback while the device 300 is held away from the user's face at arm's length, for example. The second camera 306 can provide an auto focus capability thereby allowing the user 310 to concentrate on the event 312 that is being filmed in front of the device 300. The second camera 306 can also include a roving or tracking capability that moves in conjunction with the user 310 to ensure an auto-focused and centered framing of the user 310. In this manner the user 310 can maintain the centering of the user 310 and focus of the user 310, via the second camera 306, without having to manipulate same. It is to be appreciated that once the device 300 has recorded the event 312 and the user's reaction 318 to the event 312, a display can be manipulated for displaying and/or replaying the dual recordings in, for example, a SBS or PIP arrangement. The SBS or PIP arrangement then provides for a dual viewing of two separate recordings captured by the single device. It is to be appreciated that the playback of the separate recordings can emphasize one recording over the other. In other words, the first recording can consume more viewing space than the second recording (FIG. 4), or vice versa, or alternatively both recordings can consume equal viewing space (FIG. 1).

In yet still another arrangement, both recordings from the first camera 304 and the second camera 306 are generally simultaneous. This enables recording of an event and the first person's reaction 318 (thru a second person perspective 307) to the event 312 in real time. The recording of the aforementioned simultaneous ‘events’ provides for a more enriched and interactive recording for future preservation and sharing with others. It is to be appreciated the first person 310 is recording, in essence, what they are seeing 312 and what their reaction 318 is to what they are seeing 312. To the person that receives the dual recordings, they see (i.e. during a playback) what the ‘first’ person (i.e. user) recorded 312 and what the ‘first’ person's (i.e. user's) reaction 318 was to that recording from a modified second person perspective. Thus, both the first person perspective 305 and the second person perspective 307 can be preserved. Both recordings can then be presented and viewed simultaneously in, for example, a SBS or PIP arrangement on a single viewing screen. Other presentations of the recordings can include overlaying, synching, integrating, etc., in any number of ways, the first and second recordings for a simultaneous viewing of both recordings.

In yet a further arrangement, the device 300 can record the first person perspective 305 and the second person perspective 307 in non-simultaneous recordings. The device 300 can include edit capabilities for editing one or both recordings to enhance the subject matter and to synch the two perspectives if desired. In one example, the device 300 can record the first person perspective 305 of an event 312 and then record the second person perspective 307 of the event 312 after the fact. The first person could replay the recorded event (i.e. video or slide show, etc.) and then record a second video and/or audio of the second person perspective (of the first person) whereby the first person provides visual and audio reactions and/or narration to the event as the event replay occurs. In this manner a user can narrate the first recording with a second recording while viewing the first recording (i.e. replay first recording and add second recording thereto). This enables the user to narrate and synch the audio video to the video replay. One exemplary device can comprise an electronic video/image, picture frame 400 for storing digital images and audio, including a camera 408 and audio recorder 410. It is to be appreciated that while video or still images are being played back, the user can record 412 a video and/or audio narrative for each frame thereby resulting, for example, in a narrated slide show. The narrative recording can include video and audio, or audio alone. The user can synch the narrative recording easily by advancing to the next frame 414 only after the narrative recording for the present frame has concluded. Once the narration is complete, the entire recording including the images and the audio/video recording of the narration of the images can be stored directly for archival purposes, retained on a portable memory device for transport and replay on another device, and/or for transmitting electronically to another device.

There are an infinite number of examples where capturing an event and a person's reaction to the event enhances the experience not only for the subject person, but also for all others that receive the recording thereafter. Any event where the subject person is experiencing a joyous or momentous situation is ripe for recording of not only the event but also the reaction to the event. Some examples include: winning at a gambling venue, sporting events, recording family milestones and family activities. Additionally, recording funny, scary, and/or unanticipated events provide subject matter where the reaction of the user to the event enhances the visual experience for future review and sharing.

It is to be appreciated that the device can comprise a camera, video recorder, cell phone, IPAD, tablet, computer, electronic picture frame, computer, or other electronic device that is mobile, or stationary, and capable of electronic or digital recordings. Although not shown, it is to be appreciated that the device can be hand held, chest mounted, wrist mounted, desk mounted, helmet mounted, dash cam mounted, handlebar mounted, etc., or integrated into a stationary apparatus.

In the dash cam example, the dual perspectives (views) would be a view of the driver himself and a view of the driver's perspective (view) through the windshield. In this manner, the device captures/records the driver (second person perspective), while capturing/recording what the driver sees (first person perspective). The dual recordings can include simultaneous recordings of the driver's view through the windshield while at the same time capturing the driver's reaction and emotion to the view and happenings outside the vehicle. The playback of the dual associated and respective recordings can then be placed in SBS or PIP arrangement.

It is to be appreciated that in the wrist mounted configuration, the device can be manipulated at a distance to simultaneously record a person (i.e., the user) from a second person perspective while recording an event from the first person perspective. In the wrist mounted configuration, the user can hold the device at a distance of greater than 12″ from their face.

In the helmet mounted configuration, it is to be appreciated that each camera records a first person perspective (i.e., dual first person perspectives). The first camera can record what is in front of the user and the second camera can record what is behind the user (or other opposing directions). The dual recordings provide enhanced views of what the user is experiencing, albeit without recording the second person perspective reactions of the user.

While the present disclosure has been particularly shown and described with reference to preferred embodiments, it will be understood by those skilled in the art that various changes in form and details may be made to the present disclosure without departing from the spirit and scope of the present disclosure described in the following claims.

What is claimed is:

1. An entertainment sharing system for sharing a personalized video product comprising:
the entertainment sharing system having a recording device including a display unit that is capable of recording, generating, and transmitting video images;
said recording unit capable of recording a first video image of a person;
said entertainment sharing system capable of interspersing said first video image of said person with a second stock video image to create the personalized video product;
said second stock video image is associated with a particular activity image;
said personalized video product is selected from the group consisting of side-by-side images, PIP, and foreground/background of said first video image of said person and said second stock video image; and,
said entertainment sharing system including a service network capable of transmitting said personalized video product to a selected recipient.

2. The entertainment system of claim 1, wherein the recording of said first video image of said person is initiated based on a predeterminable event of the entertainment sharing system.

3. The entertainment system of claim 2, wherein said predeterminable event is a winning game on a gambling unit.

4. The entertainment system of claim 1, further comprising a second communication interface allowing the entertainment system to communicate with said service network located outside the entertainment system.

5. An entertainment system for creating a personalized image product comprising:
said entertainment unit comprises a single device including a display unit having a graphical user interface;
said entertainment system having dual recording units recording images of a person in a second person perspective, and an event in a first person perspective;
a unit controller operatively coupled to said display unit and said recording unit;
said unit controller comprising a processor and a memory operatively coupled to said processor;
said unit controller being programmed to cause said recorded images associated with said person and said event to be generated on said display unit;
said unit controller and said graphical user interface allow said person to view said recorded images of said person and said event and edit said recorded images on a single said display unit; and,
said entertainment system further comprising a communication interface wherein the communication interface allows said recorded images to be shared with a service network.

6. The entertainment system defined in claim 5, wherein said recording of said image of a person in a second person perspective and said recording of said event in a first person perspective are simultaneous.

7. The entertainment system as defined in claim 5, wherein said images are video images.

8. The entertainment system as defined in claim 5, wherein said images are still picture images.

9. The entertainment system as defined in claim 7, wherein a first image and a second image are generated on said display unit; and,
said first image and said second image are both selected from a group of images consisting of said first person perspective image, and said second person perspective image.

10. The entertainment system as defined in claim 9, wherein said first image and said second image generated on said display unit are synchronized and simultaneous.

11. The entertainment system as defined in claim 9, wherein said first image and said second image generated on said display unit are synchronized and sequential.

12. The entertainment system as defined in claim 9, wherein said first image and said second image generated on said display unit are non-synchronized and simultaneous.

13. The entertainment system as defined in claim 9, wherein said first image and said second image generated on said display unit are non-synchronized and sequential.

14. The entertainment system as defined in claim 9, wherein said first image, and said second image generated on said display unit are synchronized and simultaneous in a split screen arrangement and predeterminable order.

15. The entertainment system as defined in claim 9, wherein said first image, and said second image generated on said display unit are synchronized and sequential in a predeterminable sequence.

16. The entertainment system as defined in claim 14, wherein said predeterminable order is selected from the group consisting of:
said first person perspective image-said second person perspective image; and,
said second person perspective image-said first person perspective image.

17. The entertainment system as defined in claim 15, wherein said predeterminable sequence is selected from the group consisting of:
said first person perspective image-said second person perspective image; and,
said second person perspective image-said first person perspective image.

18. The entertainment system as defined in claim 9, wherein said first image, and said second image generated on said display unit are non-synchronized and simultaneous in a split screen arrangement and a predeterminable order.

19. The entertainment system as defined in claim 9, wherein said first image, and said second image, generated on said display unit are non-synchronized and sequential in a predeterminable sequence.

20. The entertainment system as defined in claim 5, further comprising a stock video clip relating to an entertainment activity interspersed with said recorded video images.

21. The entertainment system as defined in claim 5, wherein said service network is a social network.

22. The entertainment system as defined in claim 5, wherein said service network is selected from the group consisting of video postcard, email, and cell phone.

23. The entertainment system as defined in claim 5, wherein sharing said recorded video images include downloading to a portable electronic device.

24. The entertainment system as defined in claim 5, wherein said unit controller capable of detecting a change of an event of said entertainment system.

25. The entertainment system as defined in claim 5, wherein the step of providing a personalized video sequence includes:
providing a video sequence including an unfinished portion; capturing personalizing imagery relating to a personality; and,
inserting the personalizing imagery into the unfinished portion.

26. The entertainment system as defined in claim 25, wherein the step of providing a personalized video sequence includes providing text.

27. The entertainment system as defined in claim 26, wherein the step of providing a personalized video sequence further includes providing personalized audio.

28. A recording device for creating a personalized image product comprising:
said recording device including a display unit having a graphical user interface;
said recording device comprising a first camera and a second camera recording a first image and a second image in a first person perspective and a second person perspective, respectively;
a unit controller operatively coupled to said display unit and said recording unit;
said unit controller comprising a processor and a memory operatively coupled to said processor; and,
said unit controller being programmed to cause said recorded images to be generated on said display unit.

29. The recording device as defined in claim 28, wherein said recording of said first image and said recording of said second image are simultaneous.

30. The recording device as defined in claim 28, wherein said unit controller and said graphical user interface allow a user to view said recorded images of said person and edit said recorded images on a single said display unit.

31. The recording device as defined in claim 28, wherein said recording device further comprising a communication interface wherein the communication interface allows said recorded images to be shared with a service network.

32. The recording device as defined in claim 28, wherein said images are video images.

33. The recording device as defined in claim 28, wherein said images are still picture images.

34. The recording device as defined in claim 28, wherein said first image and said second image generated on said display unit are synchronized and simultaneous.

35. The recording device as defined in claim 28, wherein said first image and said second image generated on said display unit are synchronized and sequential.

36. The recording device as defined in claim 28, wherein said first image and said second image generated on said display unit are non-synchronized and simultaneous.

37. The recording device as defined in claim 28, wherein said first image and said second image generated on said display unit are non-synchronized and sequential.

38. The recording device as defined in claim 28, wherein first image and said second image generated on said display unit are synchronized and simultaneous in a split screen arrangement and predeterminable order.

39. The recording device as defined in claim 38, wherein said split screen arrangement relating said first image and said second image is selected from the group consisting of: SBS images, above and below images, PIP images, and foreground and background images.

40. The recording device as defined in claim 28, wherein said first image and said second image generated on said display unit are non-synchronized and simultaneous in a split screen arrangement and a predeterminable order.

41. The recording device as defined in claim 28, wherein said first image and said second image generated on said display unit are non-synchronized and sequential, in a split screen arrangement and a predeterminable sequence.

42. A recording device for creating a personalized image product comprising:
said recording device including a display unit having a graphical user interface;
said recording device comprising a first camera and a second camera simultaneously recording a first image in a first person perspective and a second image in another first person perspective;
a unit controller operatively coupled to said display unit and said recording unit;
said unit controller comprising a processor and a memory operatively coupled to said processor; and,
said unit controller being programmed to cause said recorded images to be generated on said display unit.
